(19) United States
(12) Patent Application Publication
(10) Pub. No.: US 2008/0133744 A1
(43) Pub. Date: Jun. 5, 2008

(54) MULTIMEDIA DATA STREAMING SERVER AND METHOD FOR DYNAMICALLY CHANGING AMOUNT OF TRANSMITTING DATA IN RESPONSE TO NETWORK BANDWIDTH

(76) Inventors: Shin Young AHN, Daejeon (KR); Nah Oak SONG, Seoul (KR); Jae Doo HUH, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/947,977

(22) Filed: Nov. 30, 2007

(30) Foreign Application Priority Data
Dec. 1, 2006 (KR) 10-2006-0121050

(51) Int. Cl. G06F 15/16

(52) U.S. Cl. 709/224

(57) ABSTRACT

A multimedia data streaming server for effectively changing a transmit rate of multimedia data according to a network bandwidth that irregularly changes, and a method thereof are provided. The multimedia data streaming server includes a data storing unit, a monitoring unit, and a transmit rate controller. The data storing unit stores the multimedia data according to transmission levels, and the monitoring unit regularly monitors a network bandwidth state of a network streaming the multimedia data. The transmit rate controller increases the transmission level of the multimedia data to a default level if the network bandwidth state is getting bad while transmitting the multimedia data. Then, the transmit rate controller gradually increases or decreases the transmission level of the multimedia data from the default level gradually according to the network bandwidth state.

### CLAIM OF PRIORITY

This application claims the benefit of Korean Patent Application No. 10-2006-121050 filed on Dec. 1, 2006 in the Korean Intellectual Property Office, the disclosure of which is incorporated herein by reference.

### BACKGROUND OF THE INVENTION

1. Field of the Invention

The present invention relates to a multimedia data streaming server and a method thereof and, more particularly, to a multimedia data streaming server for effectively changing a transmit rate of multimedia data according to a network bandwidth that irregularly changes, and a method thereof.

This work was supported by the IT R&D program of MIC/IITA[2004-S-605, Development of HD Level Interactive Multimedia Service Technology over Wireless Home Network].

2. Description of the Related Art

Streaming is a real-time multimedia playing technology for receiving multimedia data through a network and playing the received multimedia data using a multimedia playing apparatus without storing it in a storing unit. The multimedia data playing apparatus may be a computer device including a personal digital assistance (PDA), a portable terminal, and a wireless display device.

When the multimedia data is provided through streaming, the multimedia data is transmitted in a form of data packet. Such data packets are not guaranteed to arrive at a receiver side without having contents deformed due to error. Or, the data packets are not guaranteed to arrive at a receiver side in an order of transmitting the data packets at a transmitter side. Furthermore, the delay of transmitting the data packets through the network is not uniform.

The multimedia playing apparatus plays received data packets after buffering a predetermined amount of data packets in order to make a user not to sense various difficulties arisen on the network, such as network delay or variation in a packet sequence in a receiver side.

If a network state, available bandwidth, is getting abruptly bad, it is difficult to play multimedia data seamlessly although a predetermined amount of data packets are buffered before reproducing.

In order to stably provide a streaming service regardless network state variation, a conventional streaming server creates and stores copies of the same multimedia data with various transmission levels and selectively transmits one of the copies according to network bandwidth state.

That is, if the network bandwidth state is bad, multimedia data with a low transmission level is provided. On the contrary, if the network bandwidth state is good, multimedia data with a high transmission level is provided. Although the multimedia data is played seamlessly, the playing quality thereof varies according to the network bandwidth state.

FIG. 1 is a diagram illustrating a wireless network based multimedia streaming system according to the related art. The conventional multimedia streaming system includes a streaming server 100 and a multimedia playing apparatus 200. The streaming server 100 includes a data communication module 110, a message analyzer 121, a transmit rate controller 122, and a data storing unit 130. The multimedia playing apparatus 200 includes a data communication module 210, a buffer 220, a message generator 230, and a player 240.

In the streaming server 100, the data communication module 110 accesses the multimedia playing apparatus 200 through a wireless network and transmits the multimedia data of the streaming server 100 to the multimedia playing apparatus 200.

The message analyzer 121 detects the network bandwidth state by analyzing a transmission state report message transmitted from the multimedia playing apparatus 200.

The transmit rate controller 122 streams multimedia data to the multimedia playing apparatus 200 by gradually increasing or decreasing the transmission level of the multimedia data.

The transmission level is used to decide a transmit rate of corresponding multimedia data, and the transmission level is in inverse proportional to the transmit rate. Herein, the transmission level will be described in detail.

The data storing unit 130 makes a plurality of copies of same multimedia data and stores the copies with different transmission levels assigned.

In the multimedia playing apparatus 200, the data communication module 210 accesses the streaming server 100 through a wireless network and receives the multimedia data transmitted from the streaming server 100.

The buffer 220 receives multimedia data transmitted from the streaming server 100 and buffers the received multimedia data.

The message generator 230 detects a buffering amount by comparing the multimedia data stored in the buffer 220 and the played multimedia data. Then, the message generator 230 creates a transmission state report message and transmits the created transmission state report message to the streaming server 100.

The player 240 plays multimedia data buffered in the buffer 220, thereby providing related services to a user.

FIG. 2 is a flowchart illustrating a method of changing a transmit rate of multimedia data in a multimedia streaming system shown in FIG. 1.

The streaming server 100 obtains multimedia data and transmits the obtained multimedia data in response to a request of streaming multimedia data from the multimedia playing apparatus 200 at step S11.

Then, the streaming server 100 regularly monitors the network bandwidth state at step S12, and determines whether the network bandwidth state is getting bad compared to a previous network bandwidth state based on the monitoring result at step S13.

If the current network bandwidth state is getting bad, the streaming server decreases the transmit rate of multimedia data by one level and transmits the multimedia data at step S14. On the contrary, if the current network bandwidth state is getting good, the streaming server transmits the multimedia data after increasing a transmit rate by one level at step S16.

If a current network bandwidth state is identical to the previous network bandwidth state, the streaming server 100 transmits the multimedia data with a current transmit rate sustained at step S17.

In the method of changing the transmit rate of the multimedia data shown FIG. 2, the transmission level of the multimedia data gradually increases according to the network bandwidth state at steps S21, S22, S23, and S24, or decreases according to the network bandwidth state at steps S25, S26, S27, and S28 shown in FIG. 3.

As described above, the network bandwidth state is monitored regularly, and the transmission level sequentially changes according to the monitoring result. Therefore, the conventional multimedia streaming method has a shortcoming that cannot effectively response to the abrupt network environment variation.

For example, it assumes that the network bandwidth state is monitored at every one second, and the transmission level is set to ‘0’. If the transmission level of multimedia data is required to change from 0 to 3 because the network bandwidth state is getting abruptly bad under the assumptions, three monitoring operations and three transmission level changing operations are required to perform for changing the transmission level from 0 to 3 according to the conventional method.

In conclusion, at least three seconds are taken to change the transmission level from 0 to 3. Therefore, the multimedia playing apparatus may have difficulty to play the multimedia data, such as playing interruption.

As described above, the conventional streaming server 100 detects the network bandwidth state through a transmission state report message provided from the multimedia playing apparatus 200. Therefore, the conventional streaming server 100 may need longer time to sense the network bandwidth state.

### SUMMARY OF THE INVENTION

The present invention has been made to solve the foregoing problems of the prior art and therefore an aspect of the present invention is to provide a multimedia media data streaming server for changing a transmit rate according to a network bandwidth state in order to quickly sense and response the abrupt variation of the network bandwidth state.

According to an aspect of the invention, the invention provides a multimedia data streaming server for effectively changing a transmit rate of multimedia data according to a network bandwidth. The multimedia data streaming server includes a data storing unit, a monitoring unit, and a transmit rate controller. The data storing unit stores the multimedia data according to transmission levels, and the monitoring unit regularly monitors a network bandwidth state of a network streaming the multimedia data. The transmit rate controller increases the transmission level of the multimedia data to a default level if the network bandwidth state is getting abruptly bad while transmitting the multimedia data. Then, the transmit rate controller gradually increases or decreases the transmission level of the multimedia data from the default level gradually according to the network bandwidth state.

According to another aspect of the invention for realizing the object, there is provided a multimedia data streaming method for changing a transmit rate of multimedia data according to a network bandwidth state in a streaming server. In the method, the multimedia data is streamed to a multimedia playing apparatus through a network, and the network bandwidth state of the network is regularly monitored. Then, the transmission level of the multimedia data changes to a default level if the network bandwidth state is getting abruptly bad while transmitting the multimedia data. After changing to the default level, the transmission level of the multimedia data gradually increases or decreases from the default level gradually according to the network bandwidth state.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating a wireless network based multimedia streaming system according to the related art;

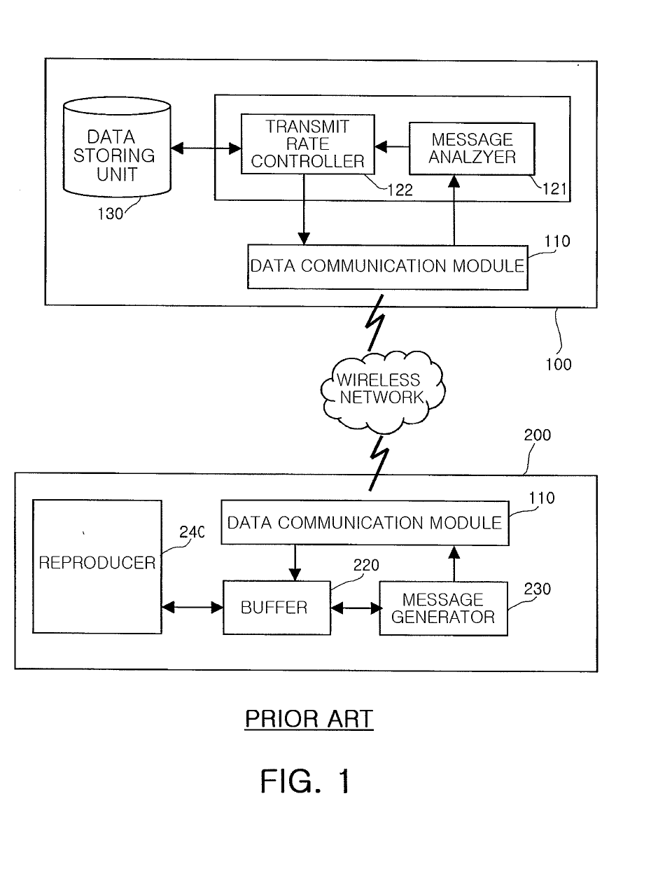

FIG. 2 is a flowchart illustrating a conventional method of changing a transmit rate of multimedia data in a multimedia streaming system shown in FIG. 1;

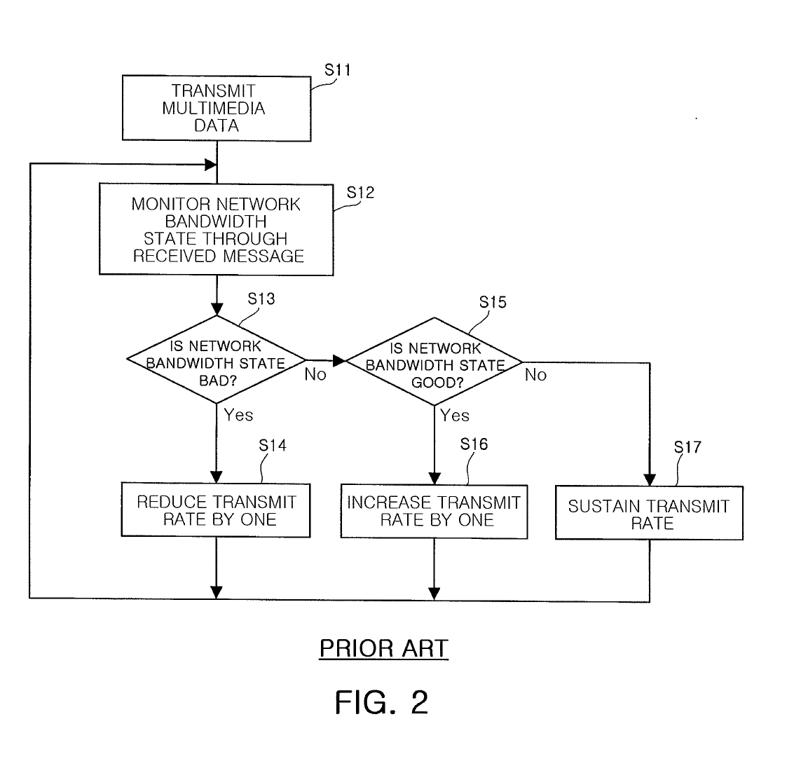

FIG. 3 is a diagram for describing a method of changing a multimedia data transmission level according to the convention method of changing a transmit rate shown in FIG. 2;

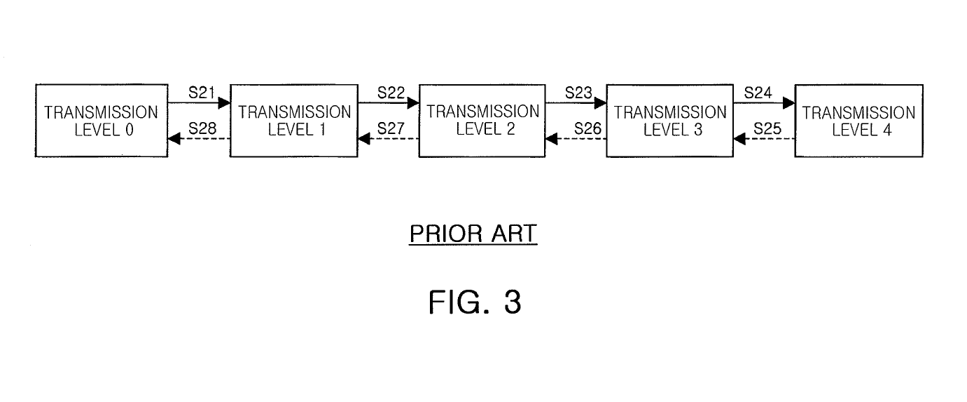

FIG. 4 is a block diagram illustrating a wireless network based multimedia streaming system according to an embodiment of the present invention;

FIG. 5 is a diagram illustrating a frame sequence per a transmit level according to an embodiment of the present invention;

FIG. 6 is a flowchart of a method of changing a transmit rate of multimedia data for a multimedia streaming system of FIG. 4; and

FIG. 7 is a diagram for describing a method of changing a multimedia data transmission level according to the method of changing a transmit rate shown in FIG. 6.

### DETAILED DESCRIPTION OF THE PREFERRED EMBODIMENT

Certain embodiments of the present invention will now be described in detail with reference to the accompanying drawings. In order to clearly describe the present invention, the descriptions of well-known functions and elements are omitted.

Also, like numeral references denote like elements in the accompanying drawings.

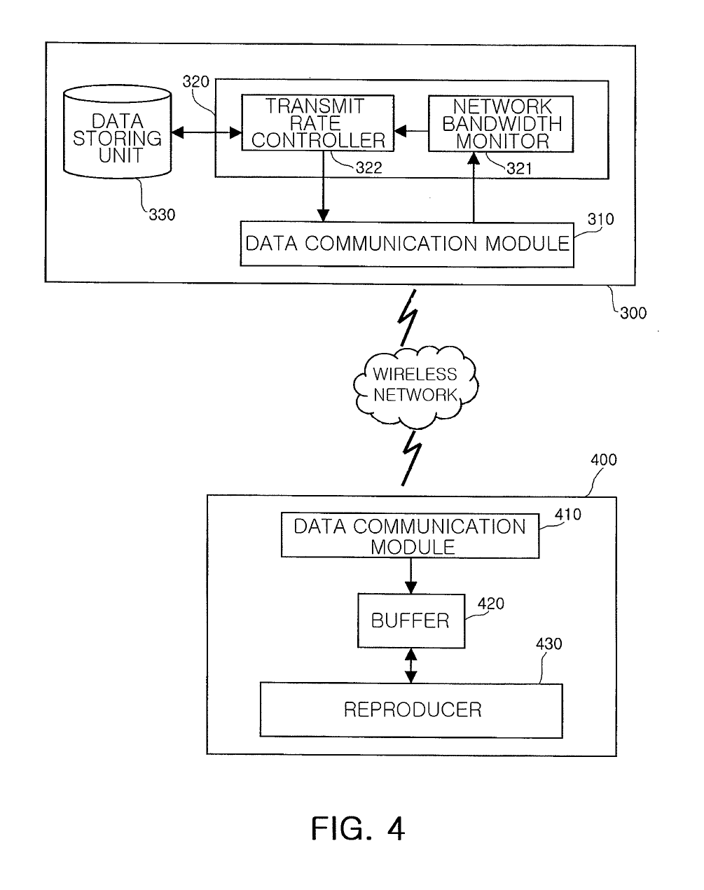

FIG. 4 is a diagram illustrating a wireless network based multimedia streaming system according to an embodiment of the present invention.

Referring to FIG. 4, the multimedia streaming system according to the present embodiment includes a streaming server 300 and a multimedia playing apparatus 400. The streaming server 300 includes a data communication module 310, a streaming controller 320, and a data storing unit 330. The streaming controller 320 includes a network bandwidth monitoring unit 321, and a transmit rate controller 322. The multimedia playing apparatus 400 includes a data communication module 410, a buffer 420, and a playing unit 430.

In the streaming server 300, the data communication module 310 accesses the multimedia playing apparatus 400 through the wireless network and transmits the multimedia data of the streaming server 300 to the multimedia playing apparatus 400.

The network bandwidth monitoring unit 321 regularly and directly monitors the network bandwidth state, and reports the monitoring result to the transmit rate controller 322. In order to directly monitor the network bandwidth state, the network bandwidth monitoring unit 321 confirms and analyzes an amount of multimedia data buffered in a transmitting end of the data communication module 310, a rate of losing multimedia data in a wireless network, and the number of retransmitting the multimedia data in the network.

The transmit rate controller 322 increases the transmission level of multimedia data to a default level if the network bandwidth state changes from a good state to a bad state, and then, the transmit rate controller 322 gradually increases or decreases the multimedia transmission level from the default level according to the network bandwidth state. Also, the transmit rate controller 322 increases the transmission level of the multimedia data by one level if the network bandwidth state is getting slightly bad while transmitting the multimedia data.

The transmit rate controller 322 sets the number of transmission levels and the default level at an initial period. The transmit rate controller 322 also divide the transmit rate of the multimedia data according the number of the set transmission levels. When the multimedia data is formed of audio data and video data, the transmit rate controller 322 divides the transmit rate of the multimedia data by adjusting the transmission level of the video data between the audio data and the video data.

The state storing unit 330 makes the copies of the same multimedia data according to the transmission levels in response to the transmit rate controller 322, and stores the copies.

In the multimedia playing apparatus 400, the data communication module 410 access the streaming server 300 through the wireless network and receives multimedia data transmitted from the streaming server 300.

The buffer 420 receives the multimedia data transmitted from the streaming server 300 and buffers the received multimedia data.

The player 430 plays the multimedia data buffered in the buffer 420 and provides related services to a user.

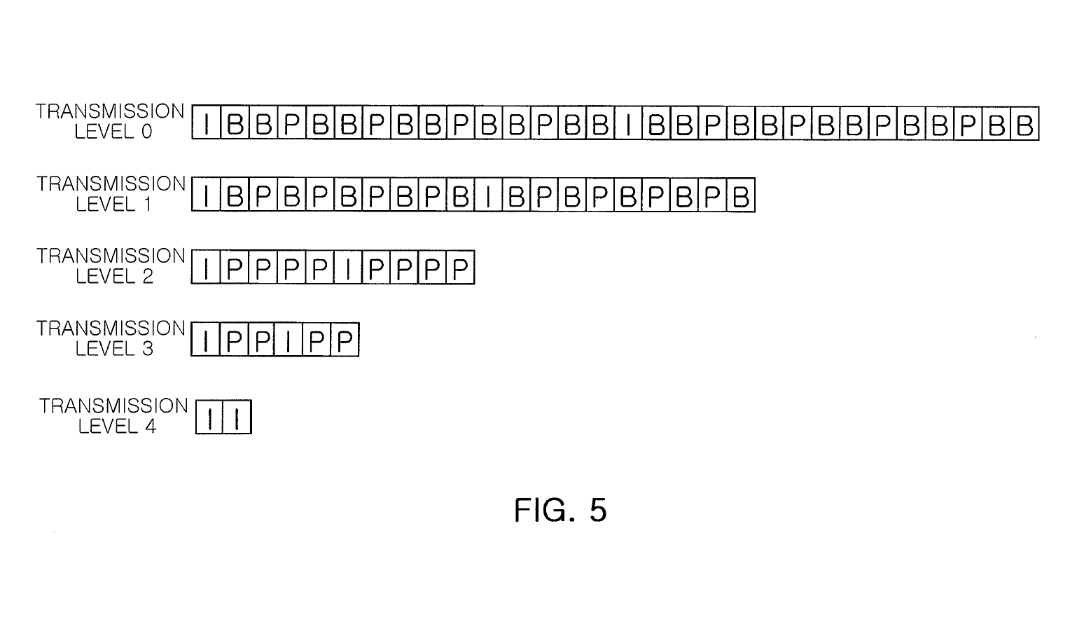

FIG. 5 is a diagram illustrating a frame sequence per a transmit level according to an embodiment of the present invention. In the method shown in FIG. 5, the transmission level is controlled by not transmitting less important pictures of I-picture, P-picture, and B-pictures forming a MPEG group of pictures (GOP).

In FIG. 5, the I-picture denotes an intra-picture. The I-picture can be independently encoded without referring to the other pictures. The I-picture is used as a reference picture to compress the other pictures. The P-picture is a picture by prediction. That is, P-picture is comparatively compressed picture with reference to the other pictures. The P-picture is created using an I-picture of a P-picture located in front of the P-picture when the picture is compressed or restored. The B-picture is a bi-directional prediction picture. The B-picture is created interpolatively using an I-picture or a P-picture located in front and back of the B-picture.

Since the I-picture is a reference picture used to create the P and B pictures, the I-picture is the most important picture. Then, the P-picture is the second most important picture, and the B-picture is the least important picture. In the present embodiment, if the network bandwidth state becomes bad, the B-pictures are deleted. If the network bandwidth state becomes further bad, the P-pictures are deleted. That is, the transmission level is controlled by selectively deleting the B-picture and the P-picture according to the network bandwidth state.

Referring to FIG. 5, the GOP with the transmission level 0 includes all I, P, and B-pictures. The GOP with the transmission level 1 includes all I and P pictures and some of the B-picture, for example, odd number B-pictures or even number B-pictures. The GOP with the transmission level 2 includes all of I and P pictures only. The GOP with the transmission level 3 includes all I-pictures and some of P-pictures, and the GOP with the transmission level 4 includes all I pictures only.

As described above, the transmit rates are different according to the transmission level although the identical multimedia data is transmitted.

In the present embodiment, if the network bandwidth is in the good state, the multimedia data with the low transmission level having the high transmit rate is transmitted. On the contrary, if the network bandwidth is in the bad state, the multimedia data with the high transmission level having the low transmit rate is transmitted, thereby enabling the multimedia playing apparatus 400 to play the multimedia data seamlessly. Only, the picture quality of the played multimedia data changes according to the network bandwidth state.

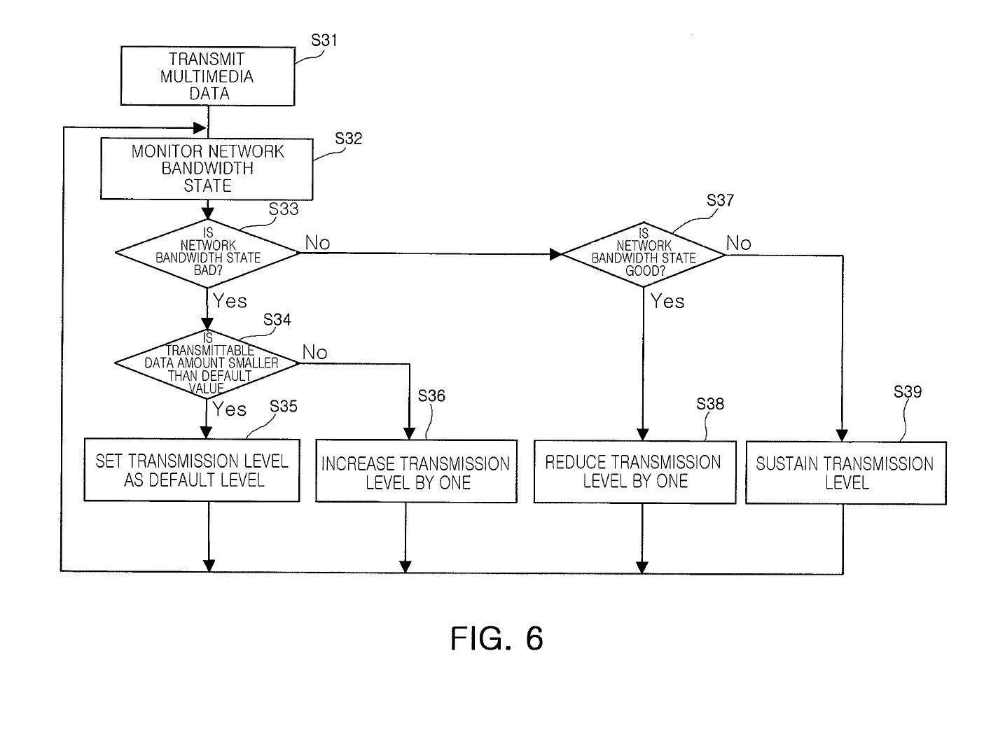

FIG. 6 is a flowchart of a method of changing a transmit rate of multimedia data for a multimedia streaming system of FIG. 4. In FIG. 6, the default level is assumed as the transmission level 3.

The streaming server 300 obtains and transmits multimedia data in response to a request of streaming multimedia data from the multimedia playing apparatus 400 at step S31.

Then, the streaming server 300 regularly monitors the network bandwidth state at step S32 and determines whether the network bandwidth state is getting bad or not based on the monitoring result at step S33.

If the streaming server 300 determines that the network bandwidth state is getting bad based on the monitoring result, the streaming server 300 determined whether a transmission level suitable to a current bandwidth state by determining whether an amount of data transmittable through the current network bandwidth is smaller than a default amount or not at step S34. Herein, the default value is a data amount for confirming that the network bandwidth state is getting bad abruptly. The default value can be set or modified by a user.

If the transmission level suitable to the current network bandwidth state is the default level, the streaming server determines that the current network bandwidth state is getting bad abruptly. Accordingly, the streaming server sets the transmission level of the multimedia data to the default level and transmits the multimedia data with the default level at step S35.

On the contrary, if the transmission level suitable to the current network bandwidth state is not the default level, the streaming server determines that the current network bandwidth state is getting slightly bad and transmits the multimedia data with one-level higher transmission level higher than the current transmission level at step S36.

If the network bandwidth state is getting good at step S37, the streaming server transmits the multimedia data with one level lower transmission level than the current transmission level at step S38. If the network bandwidth state is identical to the previous state, the streaming server transmits the multimedia data with the transmission level sustained at step S39.

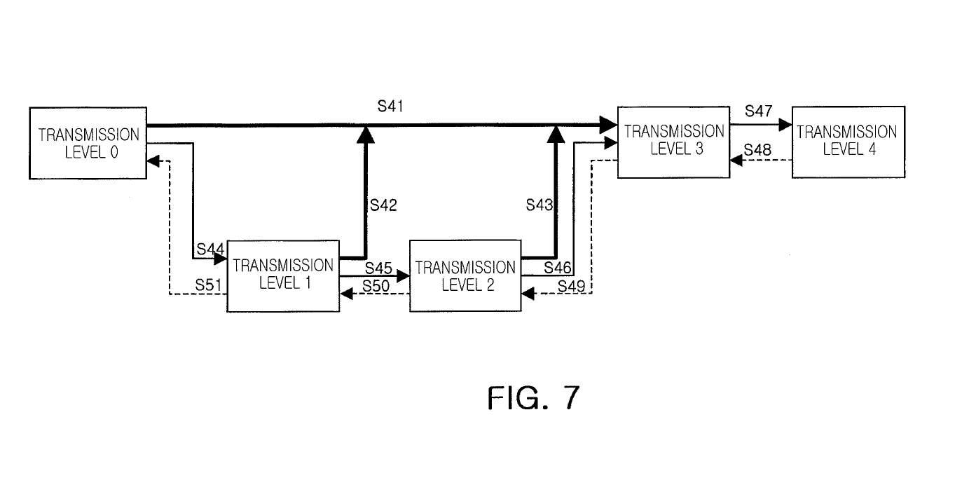

In the method of changing the transmit rate of the multimedia data shown in FIG. 6, if the network bandwidth state is getting abruptly bad as shown in FIG. 7, the transmission level of the multimedia data increases to a default level, transmission level 3, at step S41, S42 and S43. Then, the transmission level gradually increases at step S44, S45, S46, and S47 or gradually decreases at step S48, S49, S50, and S51 according to the network bandwidth state.

The multimedia playing apparatus according to certain embodiment of the present invention was described not to have the message generator. However, the multimedia playing apparatus according to an embodiment of the present invention may include the message generating unit according to needs like as the conventional multimedia playing apparatus.

As described above, the multimedia data streaming server for changing a transmit rage according to a network bandwidth state according to the certain embodiment of the present invention directly analyzes the network bandwidth state by itself. Therefore, the multimedia data streaming server according to the certain embodiment of the present invention can quickly detect the network bandwidth state variation. If the network bandwidth state is getting degraded abruptly, the multimedia data streaming server according to the present embodiment can instantly reduce the transmit rate of the multimedia data. Therefore, the multimedia data streaming server according to the certain embodiments of the present invention can effectively response the abrupt network bandwidth variation.

While the present invention has been shown and described in connection with the preferred embodiments, it will be apparent to those skilled in the art that modifications and variations can be made without departing from the spirit and scope of the invention as defined by the appended claims.

What is claimed is:

1. A multimedia data streaming server for changing a transmit rate of multimedia data according to a network bandwidth state, comprising:
a data storing unit for storing the multimedia data according to transmission levels;
a monitoring unit for regularly monitoring a network bandwidth state of a network streaming the multimedia data; and
a transmit rate controller for increasing the transmission level of the multimedia data to a default level if the network bandwidth state is getting abruptly bad while transmitting the multimedia data and gradually increasing or decreasing the transmission level of the multimedia data from the default level gradually according to the network bandwidth state.

2. The multimedia data streaming server according to claim 1, wherein the transmit rate controller increases the transmission level of the multimedia data by one level if the network bandwidth state is getting slightly bad while transmitting the multimedia data.

3. The multimedia data streaming server according to claim 1, wherein the transmit rate controller sets the number of the transmission levels and the default level, and dividing the transmit rate of the multimedia data according to the number of transmission levels.

4. The multimedia data streaming server according to claim 3, wherein the transmit rate controller divides the transmit rate of the multimedia data by adjusting a transmission level of the video data if the multimedia data is formed of audio data and video data.

5. The multimedia data streaming server according to claim 1, wherein the monitoring unit determines the network bandwidth state based on an amount of the multimedia data in a buffer to transmit to the multimedia playing apparatus, an amount of the multimedia data lost in the network, and the number of retransmitting the multimedia data in the network.

6. The multimedia data streaming server according to claim 1, wherein the multimedia data streaming server further comprises a data communication module for accessing a multimedia playing apparatus and transmitting the multimedia data to the multimedia playing apparatus.

7. The multimedia data streaming server according to claim 1, wherein the network is a wireless network.

8. A multimedia data streaming method for changing a transmit rate of multimedia data according to a network bandwidth state in a streaming server, comprising the steps of:
streaming the multimedia data to a multimedia playing apparatus through a network;
regularly monitoring the network bandwidth state of the network; and
increasing the transmission level of the multimedia data to a default level if the network bandwidth state is getting abruptly bad while transmitting the multimedia data and gradually increasing or decreasing the transmission level of the multimedia data from the default level gradually according to the network bandwidth state.

9. The multimedia data streaming method according to claim 8, further comprising step of increasing the transmission level of the multimedia data by one level if the network bandwidth state is getting slightly bad while transmitting the multimedia data.

10. The multimedia data streaming method according to claim 8, further comprising the step of setting the number of the transmission levels and the default level, and dividing the transmit rate of the multimedia data according to the number of transmission levels.

11. The multimedia data streaming method according to claim 10, wherein the multimedia data is formed of audio data and video data, and the transmit rate is divided by adjusting a transmission level of the video data if the multimedia data is formed of audio data and video data.

12. The multimedia data streaming method according to claim 8, wherein the network bandwidth state is determined based on an amount of the multimedia data in a buffer to transmit to the multimedia playing apparatus, an amount of the multimedia data lost in the network, and the number of retransmitting the multimedia data in the network.

13. The multimedia data streaming method according to claim 8, wherein the network is a wireless network.
